(19) United States
(12) Patent Application Publication
(10) Pub. No.: US 2009/0189073 A1
(43) Pub. Date: Jul. 30, 2009

(54) MASS SPECTROMETRY SYSTEM

(75) Inventor: Shinichi YAMAGUCHI, Kyoto-shi (JP)

Correspondence Address: SUGHRUE MION, PLLC, 2100 PENNSYLVANIA AVENUE, N.W., SUITE 800, WASHINGTON, DC, 20037, US

(73) Assignee: SHIMADZU CORPORATION, Kyoto-shi (JP)

(21) Appl. No.: 12/351,319

(22) Filed: Jan. 9, 2009

(30) Foreign Application Priority Data
Jan. 24, 2008 (JP) 2008-013664

(51) Int. Cl. H01J 49/00

(52) U.S. Cl. 250/288

(57) ABSTRACT

A mass spectrometry system, in which a sample is introduced into each of a triple quadrupole-type mass spectrometry apparatus and another mass spectrometry apparatus, approximately concurrently in a parallel manner. The triple quadrupole-type mass spectrometry apparatus is operable to perform a neutral loss scan, and, when a specific ion is detected, a data processing section is operable to instruct a control section to initiate a mass spectrometric analysis in the other mass spectrometry apparatus. The control section is operable to control each device of the other mass spectrometry apparatus to allow the other mass spectrometry apparatus to perform a mass spectrometric analysis for the specific ion with a high degree of accuracy. A data integration processing section is operable to integrate respective analysis results obtained by data processing sections as if they are obtained from a single mass spectrometry apparatus.

### BACKGROUND OF THE INVENTION

1. Field of the Invention

The present invention relates to a mass spectrometry system designed to analyze the same sample using a plurality of mass spectrometry apparatuses.

2. Description of the Related Art

As one of the mass spectrometry strategies, there has been known a technique called “MS/MS analysis (tandem analysis)” for identifying a substance having a large molecular mass and/or analyzing a structure thereof. Among various apparatuses for MS/MS analysis, the easiest type to operate and handle is a triple quadrupole (TQ)-type mass spectrometry apparatus.

As disclosed, for example, in JP 07-201304A, the triple quadrupole-type mass spectrometry apparatus is designed as follows. Ions originating from components of a sample and generated in an ion source are introduced into a first stage quadrupole to select therefrom an ion having a specific mass (mass-to-charge ratio m/z) as a precursor ion. The precursor ion is introduced into a collision cell internally provided with a second stage quadrupole. In the collision cell which is supplied with a collision-induced dissociation (CID)-inducing gas, such as argon, the precursor ion is fragmented through collision with the CID-inducing gas to form various product ions. The product ions are introduced into a third stage quadrupole to select therefrom a product ion having a specific mass, and the selected product ion is delivered to and detected by a detector.

In the triple quadrupole-type mass spectrometry apparatus, a high-frequency voltage and a DC voltage to be applied to the first stage quadrupole can be changed to perform a mass scan for precursor ions. Further, a high-frequency voltage and a DC voltage to be applied to the third stage quadrupole can be changed to perform a mass scan for product ions delivered to the detector, so as to create an MS² spectrum.

In addition, the triple quadrupole-type mass spectrometry apparatus is capable of performing distinctive analyses, such as a precursor ion scan for detecting any precursor ion from which a product ion with a specific mass has been formed, and a neutral loss scan for detecting any precursor ion from which a neutral fragment (neutral chemical species) with a specific mass has been dissociated, so as to obtain information useful for estimating a chemical structure of a sample. Furthermore, the triple quadrupole-type mass spectrometry apparatus is excellent in ion fragmentation efficiency and ion transmission efficiency, and therefore has high detection sensitivity, particularly, excellent quantitative capability.

On the other hand, the triple quadrupole-type mass spectrometry apparatus is generally low in mass accuracy and mass resolution, and thereby mass information obtained by the above distinctive analytical techniques cannot be sufficiently utilized in some cases. Moreover, in late years, a molecular mass of a target substance to be analyzed has become increasingly large, which is likely to cause difficulty in obtaining fragment ions with a small size suitable for analysis, by a single-stage fragmentation operation. Particularly, in the triple quadrupole-type mass spectrometry apparatus incapable of performing a multistage (two or more-stage) fragmentation operation, the above tendency gives rise to a problem that an analysis result is obtained in a half-finished or incomplete state.

### SUMMARY OF THE INVENTION

In view of the above circumstances, it is an object of the present invention to provide a mass spectrometry system capable of acquiring a wealth of information about a sample in a simple manner, using a combination of a triple quadrupole-type mass spectrometry apparatus and another type of mass spectrometry apparatus different, for example, in mass separation method, while utilizing features of the triple quadrupole-type mass spectrometry apparatus, and adequately maintaining a cooperative (e.g., tandem) operation between the plurality of mass spectrometry apparatuses.

For reference, a technique of introducing the same sample into a plurality of mass spectrometry apparatuses and performing analysis in a parallel manner has heretofore been known, as disclosed, for example, in JP 2005-353340A. This conventional technique is solely intended to use a combination of a plurality of different types of ion sources, and thus incapable of achieving the above object.

In order to achieve the above object, according to a first aspect of the present invention, there is provided a mass spectrometry system which comprises a) a first mass spectrometry apparatus which is a triple quadrupole-type mass spectrometry apparatus, b) a second mass spectrometry apparatus using a mass separation method different from that in the first mass spectrometry apparatus and having a capability to achieve a mass accuracy greater than that of the first mass spectrometry apparatus, c) sample introduction means adapted to introduce a same sample into each of the first mass spectrometry apparatus and the second mass spectrometry apparatus, simultaneously or with a given time delay therebetween, in a parallel manner, d) information extraction means operable, based on a detection signal obtained by a mass spectrometric analysis in the first mass spectrometry apparatus with respect to the sample introduced by the sample introduction means, to extract information about a predetermined specific ion, and e) control means operable to control an operation of the second mass spectrometry apparatus to allow the second mass spectrometry apparatus to perform a mass spectrometric analysis for the specific ion originating from the sample introduced by the sample introduction means, in accordance with the information extracted by the information extraction means.

According to a second aspect of the present invention, there is provided a mass spectrometry system which comprises a) a first mass spectrometry apparatus which is a triple quadrupole-type mass spectrometry apparatus, b) a second mass spectrometry apparatus using a mass separation method different from that in the first mass spectrometry apparatus and having a capability to achieve a mass accuracy greater than that of the first mass spectrometry apparatus, c) sample introduction means adapted to selectively introduce a same sample into either one of the first mass spectrometry apparatus and the second mass spectrometry apparatus, d) information extraction means operable, based on a detection signal obtained by a mass spectrometric analysis in the first mass spectrometry apparatus with respect to the sample introduced by the sample introduction means, to extract information about a predetermined specific ion, and e) file creation means operable, based on the information about the specific ion extracted by the information extraction means, to create a file including an analytical condition and procedure for allowing the second mass spectrometry apparatus to perform a mass spectrometric analysis for the specific ion, and f) control means operable to control an operation of the second mass spectrometry apparatus to allow the second mass spectrometry apparatus to perform the mass spectrometric analysis for the specific ion originating from the sample introduced by the sample introduction means, in accordance with the file created by the file creation means.

According to a third aspect of the present invention, there is provided a mass spectrometry system which comprises a) a first mass spectrometry apparatus which is a triple quadrupole-type mass spectrometry apparatus, b) a second mass spectrometry apparatus operable to repeat an operation of selecting a specific ion and inducing fragmentation of the selected ion, twice or more, to form product ions, so as to perform an MSⁿ analysis for the product ions to obtain an MSⁿ analysis result (wherein n is an integer of 3 or more), c) sample introduction means adapted to introduce a same sample into each of the first mass spectrometry apparatus and the second mass spectrometry apparatus, simultaneously or with a given time delay therebetween, in a parallel manner, d) information extraction means operable, based on a detection signal obtained by a mass spectrometric analysis in the first mass spectrometry apparatus with respect to the sample introduced by the sample introduction means, to extract information about a predetermined specific ion, and e) control means operable to control an operation of the second mass spectrometry apparatus to allow the second mass spectrometry apparatus to perform the MSⁿ analysis for the specific ion originating from the sample introduced by the sample introduction means and serving as a target ion, in accordance with the information extracted by the information extraction means.

According to a fourth aspect of the present invention, there is provided a mass spectrometry system which comprises a) a first mass spectrometry apparatus which is a triple quadrupole-type mass spectrometry apparatus, b) a second mass spectrometry apparatus operable to repeat an operation of selecting a specific ion and inducing fragmentation of the selected ion, twice or more, to form product ions, so as to perform an MSⁿ analysis for the product ions to obtain an MSⁿ analysis result (wherein n is an integer of 3 or more), c) sample introduction means adapted to selectively introduce a same sample into either one of the first mass spectrometry apparatus and the second mass spectrometry apparatus, d) information extraction means operable, based on a detection signal obtained by a mass spectrometric analysis in the first mass spectrometry apparatus with respect to the sample introduced by the sample introduction means, to extract information about a predetermined specific ion, and e) file creation means operable, based on the information about the specific ion extracted by the information extraction means, to create a file including an analytical condition and procedure for allowing the second mass spectrometry apparatus to perform the MSⁿ analysis for the specific ion, and f) control means operable to control an operation of the second mass spectrometry apparatus to allow the second mass spectrometry apparatus to perform the MSⁿ analysis for the specific ion originating from the sample introduced by the sample introduction means and serving as a target ion, in accordance with the file created by the file creation means.

In the mass spectrometry system according to each of the first to fourth aspect of the present invention, the second mass spectrometry apparatus may comprise a mass separation section configured as a time-of-flight mass separation section. In this case, the second mass spectrometry apparatus can have a mass accuracy ten times or more greater than that of the triple quadrupole-type mass spectrometry apparatus (i.e., first mass spectrometry apparatus). In an MSⁿ analysis, it is preferable to use a three-dimensional quadrupole ion trap, although a linear ion trap may also be used.

In the mass spectrometry system according to each of the first to fourth aspect of the present invention, the first mass spectrometry apparatus is operable to perform a precursor ion scan or a neutral loss scan to detect a specific ion based on a result of the scan. In the triple quadrupole-type mass spectrometry apparatus (i.e., first mass spectrometry apparatus), the precursor ion scan can be readily achieved by scanning a mass or mass range for mass selection of precursor ions in a preceding-stage mass separator (first-stage quadrupole) under a condition that a mass or a mass range for mass selection of product ions in a subsequent-stage mass separator (third-stage quadrupole) is fixed to a predetermined value or range. The neutral loss scan can be readily achieved by scanning a mass or mass range for mass selection in a preceding-stage mass separator (first-stage quadrupole) under a condition that a difference in mass between a precursor ion in the preceding-stage mass separator (first-stage quadrupole) and a corresponding product ion in a subsequent-stage mass separator (third-stage quadrupole) is kept constant.

As above, in the mass spectrometry system according to each of the first to fourth aspect of the present invention, detailed information about a specific ion distinctively detected in the triple quadrupole-type mass spectrometry apparatus, for example, using a precursor ion scan or a neutral loss scan, specifically, detailed (high-accuracy) mass information about a specific ion and detailed mass information about various product ions formed through fragmentation of the specific ion, can be acquired in a simple manner. This makes it possible to search a target component of a sample and acquire mass information about the target component with a high degree of mass accuracy (which is difficult with a triple quadrupole-type mass spectrometry apparatus), by utilizing features of the triple quadrupole-type mass spectrometry apparatus.

In the mass spectrometry system according to each of the first and third aspect of the present invention, the mass spectrometric analysis in the first mass spectrometry apparatus and the mass spectrometric analysis (or MSⁿ analysis) in the second mass spectrometry apparatus are performed approximately simultaneously in a parallel manner. This makes it possible to avoid an increase in requited analysis time, even in a mass spectrometry system where a sample-component separation section requiring a certain amount of time for separating components of a sample, such as a gas chromatograph or a or liquid chromatograph, is used in combination with the first and second mass spectrometry apparatuses.

In the mass spectrometry system according to each of the second and fourth aspect of the present invention, a first cycle of analysis is performed in the first mass spectrometry apparatus, and then the file creation means creates the file for controlling the mass spectrometric analysis or MSⁿ analysis) in the second mass spectrometry apparatus with respect to the same sample. In the point that the second cycle of analysis is performed temporally separately from the first cycle of analysis, a total analysis time becomes longer. Conversely, a time for verifying adequateness of the first cycle of analysis in first mass spectrometry apparatus can be ensured to avoid the second cycle of analysis in the second mass spectrometry apparatus in some situations.

A sample component to be introduced into the first and second mass spectrometry apparatuses is likely to be changed over time, as in sample components separated by a chromatograph. In the mass spectrometry system according to each of the first and third aspect of the present invention, it is necessary to adjust a sample introduction timing, for example, to introduce a sample (sample component) into the second mass spectrometry apparatus with a delay time corresponding to a time required for processing data about the same sample (same sample component) introduced into the first mass spectrometry apparatus, in order to allow the first and second mass spectrometry apparatuses to analyze the same sample component. In contract, in the mass spectrometry system according to each of the second and fourth aspect of the present invention, the first and second mass spectrometry apparatuses are originally designed to perform analysis in different time zones independently, and therefore the adjustment of the sample introduction timing is not required.

In the mass spectrometry system according to each of the first and third aspect of the present invention, an analysis result, such as a mass spectrum, is obtained in each of the first and second mass spectrometry apparatuses. In view of user-friendliness, it is desirable that the two analysis results are displayed or processed as if they are an analysis result obtained by a single mass spectrometry apparatus. Therefore, the mass spectrometry system of the present invention is preferably configured to integrate respective analysis results obtained by the first and second mass spectrometry apparatuses with respect to the same sample, and display or process the integrated analysis result.

### BRIEF DESCRIPTION OF THE DRAWINGS

FIG. 1 is a block diagram schematically showing a mass spectrometry system according to a first embodiment of the present invention.

FIG. 2 is a block diagram schematically showing a mass spectrometry system according to a second embodiment of the present invention.

FIG. 3 is a graph conceptually showing a mass spectrum obtained by a neutral loss scan.

FIG. 4 is a graph conceptually showing a mass spectrum obtained by a precursor ion scan.

### DESCRIPTION OF THE EXEMPLARY EMBODIMENTS

With reference to the drawings, the present invention will now be described based on an embodiment thereof.

### First Embodiment

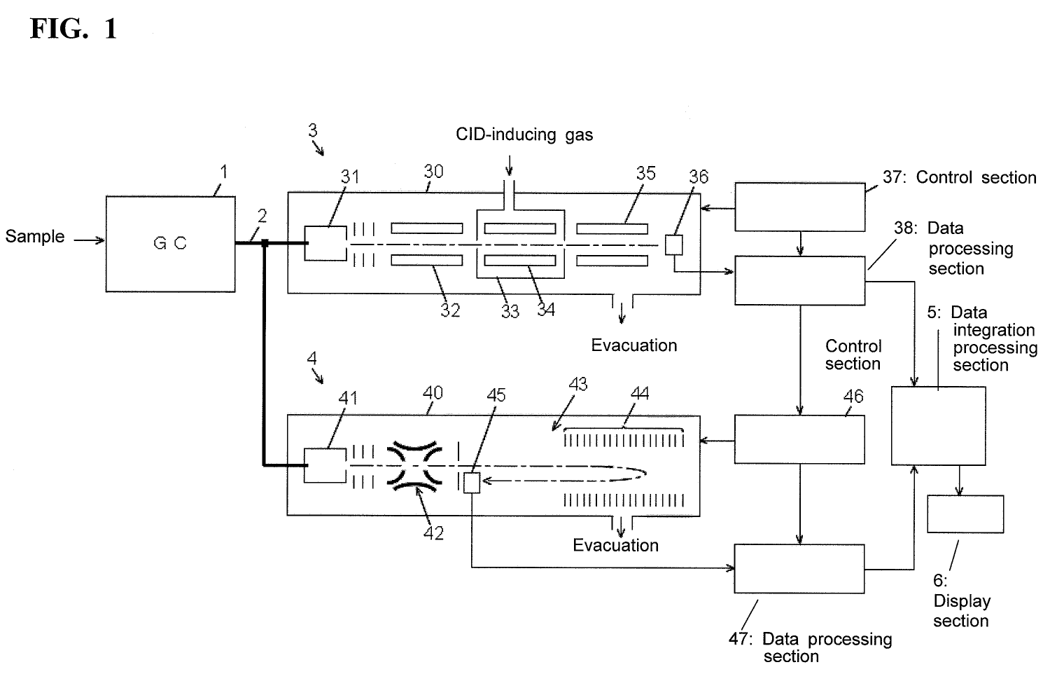

FIG. 1 is a block diagram schematically showing a mass spectrometry system according to a first embodiment of the present invention.

The mass spectrometry system according to the first embodiment comprises two types of mass spectrometry apparatus consisting of a triple quadrupole-type mass spectrometry apparatus 3 and an ion trap time-of-flight mass spectrometry apparatus 4, and a sample introduction section 2 for allowing components of a sample separated by a gas chromatograph (GC) section 1 to be introduced into each of the mass spectrometry apparatuses 3, 4 in a parallel manner. Preferably, in consideration of a time required for an after-mentioned data processing and others, a timing of introducing the sample into the ion trap time-of-flight mass spectrometry apparatus 4 is adjusted to be slightly later than that of introducing the same sample into the triple quadrupole-type mass spectrometry apparatus 3. The adjustment of the sample introduction timing may be performed by adjusting a length of a passage for introducing the sample, or by introducing a make-up (i.e., carrier) gas into the sample introduction section 2 and adjusting a flow rate of the gas.

The triple quadrupole-type mass spectrometry apparatus 3 comprises an ion source 31 for ionizing a sample, a first-stage quadrupole 32 serving as a first separation section, a collision cell 33 internally provided with a second-stage quadrupole 34, a third-stage quadrupole 35 serving as a second mass separation section, a detector 36 for detecting ions, and an analysis chamber 30 housing the above devices in an internal space thereof evacuated by a vacuum pump (not shown). An operation of each of the devices is controlled by a control section 37, and a detection signal from the detector 36 is input into a data processing section 38. Typically, a voltage formed by a superimposing a high-frequency voltage on a DC voltage is applied to each of the first-stage quadrupole 32 and the third-stage quadrupole 35, and only a high-frequency voltage is applied to the second-stage quadrupole 34. According to need, a DC bias voltage may be additionally applied to each of the three quadrupoles 32, 34, 35. The second-stage quadrupole 34 is provided as a means to transport ions toward a downstream side while focusing the ions by a high-frequency electric field, without a mass selection function. Thus, the second-stage quadrupole 34 may be formed in any other suitable multipolar configuration other than quadrupole, such as hexapole or octopole.

The ion trap time-of-flight mass spectrometry apparatus 4 comprises an ion source 41 for ionizing a sample, a three-dimensional quadrupole ion trap 42 for temporarily holding ions, a time-of-flight separation section 43 having a reflectron electrode 44 disposed in a flight space thereof to reflect ions, a detector 45 for detecting ions, and an analysis chamber 40 housing the above devices in an internal space thereof evacuated by a vacuum pump (not shown). An operation of each of the devices is controlled by a control section 46, and a detection signal from the detector 45 is input into a data processing section 47. The control section 46 has a function of setting a control procedure and condition based on signals and information obtained from the data processing section 38.

The mass spectrometry system further includes a data integration processing section 5 operable, in response to receiving data acquired by the data processing section 38 associated with the triple quadrupole-type mass spectrometry apparatus 3, and data acquired by the data processing section 47 associated with the ion trap time-of-flight mass spectrometry apparatus 4, to integrate the received data into a format as close as data obtained from a single mass spectrometry apparatus, and display the integrated data on a display section 6 while storing the integrated data in a storage device (not shown).

One example of a distinctive operation of the mass spectrometry system according to the first embodiment will be described below. Various components contained in a target sample to be analyzed are temporally separated by the GC section 1, and supplied to each of the ion sources 31, 41 of the mass spectrometry apparatuses 3, 4 via the sample introduction section 2.

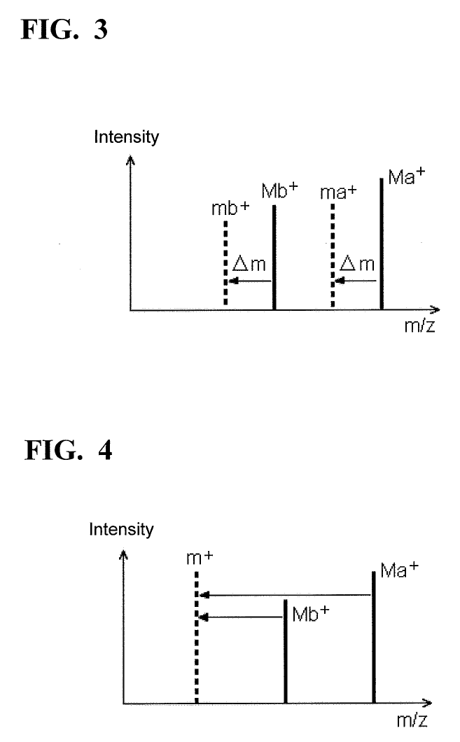

In the triple quadrupole-type mass spectrometry apparatus 3, various ions generated in the ion source 31 based on the sample introduced from the sample introduction section 2 are subjected to a neutral loss scan to search a specific ion (precursor ion) from which a product ion with a specific mass difference therefrom has been formed by fragmentation. FIG. 3 is a graph conceptually showing a mass spectrum obtained by the neutral loss scan.

A difference Δm (=M−m) between a mass M (Ma, Mb) of a precursor ion selected by the first-stage quadrupole 32, and a mass m (ma, mb) of a corresponding product ion to be selected by the third-stage quadrupole 35, is controlled to be a constant value. For this purpose, the control section 37 is operable to repeatedly change a voltage to be applied to the first-stage quadrupole 32 and a voltage to be applied to the third-stage quadrupole 35, so as to keep the mass difference Δm at a certain constant value. The mass difference Δm may be predetermined depending on a target sample component to be analyzed. Typically, in cases where it is known that a fragment having a common mass, which originates from a specific partial structure or functional group, is dissociated from a precursor ion by fragmentation, the mass difference Δm is pre-set based on a mass of such a fragment to be dissociated.

For example, the data processing section 38 is operable to sequentially receive detection signals obtained by the detector 36 according to the repetition of the neutral loss scans, and sum ion intensities obtained by the respective scans to create a total ion chromatogram. When a peak appears on the chromatogram, it can be determined that a target sample component is eluted from the GC section at that timing. Thus, the data processing section 38 is operable to detect the peak, and acquire information about a mass of a precursor ion at the time when the peak is detected. The mass information is immediately sent to the control section 46. Then, the control section 46 is operable to control the respective devices of the ion trap time-of-flight mass spectrometry apparatus 4 to allow the ion trap time-of-flight mass spectrometry apparatus 4 to perform a detailed mass spectrometric analysis for an ion having the mass.

Specifically, the ion source 41 generates ions based on components of a sample introduced through the sample introduction section 2, and sends the generated ions to the ion trap 42. The ion trap 42 cools the ions and temporarily holds the cooled ions. There is a time lag between the introduction of a target sample component into the triple quadrupole-type mass spectrometry apparatus 3 and the detection of a specific ion by the data processing section 38. Thus, the same target sample component is introduced into the ion trap time-of-flight mass spectrometry apparatus 4 with a delay time, so that specific ions originating from the target sample component can be accumulated in the ion trap 42. Then, at a given timing, energy is given to the ions held in the ion trap 42 approximately concurrently to eject the ions from the ion trap 42 into the time-of-flight separation section 43.

In the time-of-flight separation section 43, the ions are turned back according to a DC electric field formed by the reflectron electrode 44, and finally delivered to the detector 45. A flight time of each ion depends on a mass of the ion. Thus, the data processing section 47 is configured to accurately measure the flight time so as to detect a mass of each ion with a high degree of accuracy. Generally, an ion trap time-of-flight mass spectrometry apparatus has a mass accuracy and a mass resolution about ten to one hundred times greater than those of a triple quadrupole-type mass spectrometry apparatus 3.

As above, in an ion trap time-of-flight mass spectrometry apparatus, a measurement accuracy of a flight time is directly linked to an accuracy of a mass spectrometric analysis, and a certain amount of flight time is required to increase a mass accuracy. Thus, it is difficult to repeatedly perform the analysis at short time intervals. In the mass spectrometry system according to the first embodiment, after a specific ion is detected by the triple quadrupole-type mass spectrometry apparatus 3, the ion trap time-of-flight mass spectrometry apparatus 4 starts a detailed mass spectrometric analysis for the specific ion. Thus, the ion trap time-of-flight mass spectrometry apparatus 4 can acquire high-accuracy mass information about a specific ion as a user's target. Then, respective data obtained by the data processing sections 38, 47 are collected to the data integration processing section 5, and integrated into a format as close as a data obtained by a single mass spectrometry apparatus. Thus, a user can readily handle the integrated data in the same manner as that in observation/analysis/processing of a result obtained by a single mass spectrometry apparatus, without regard to a fact that the integrated data is obtained from the two different mass spectrometry apparatuses 3, 4.

The triple quadrupole-type mass spectrometry apparatus 3 may employ various analysis techniques other than the neutral loss scan. FIG. 4 is a graph conceptually showing a mass spectrum obtained by a precursor ion scan as one example of the other analysis techniques. The precursor ion scan is designed to scan any precursor ion from which a product ion with a specific ion m has been formed by fragmentation. In the precursor ion scan, under a condition that a given voltage is applied to the third-stage quadrupole 35 to allow only a specific product ion having a predetermined mass to pass therethrough (i.e., to be selected), a voltage to be applied to the first-stage quadrupole 32 is changed to scan precursor ions. Then, when a specific product ion passing through the third-stage quadrupole 35 is detected by the detector 36, precursor ions passing through the first-stage quadrupole 32 are identified.

In the ion trap time-of-flight mass spectrometry apparatus 4, an operation of inducing fragmentation of a precursor ion by a collision with a CID-inducing gas introduced into the ion trap 42, selecting a product ion having a specific mass from various product ions formed by the fragmentation, and inducing fragmentation of the selected product ion as a secondary precursor ion by a collision with the CID-inducing gas may be repeated plural times. In this case, after a specific ion is detected by the mass spectrometric analysis in the triple quadrupole-type mass spectrometry apparatus 3, a precursor ion having the same mass of the specific ion is subjected to fragmentation given times in the ion trap 42 so as to perform an MSⁿ analysis to obtain an MSⁿ spectrum. The triple quadrupole-type mass spectrometry apparatus 3 is capable of performing a fragmentation operation only once to thereby provide only an MS¹ spectrum (standard mass spectrum) or an MS² mass spectrum. In contrast, the ion trap time-of-flight mass spectrometry apparatus 4 can provide an MSⁿ spectrum (n: integer of 3 or more). When a target sample component has a large molecular mass or low fragmentability, a precursor ion originating from the sample component is highly likely to have difficulty in being fragmented into product ions having a sufficiently small mass only by one fragmentation operation. In contrast, the above multi-stage fragmentation operation makes it possible to allow such a precursor ion to be fragmented into product ions having a sufficiently small mass, so that information useful for analysis of a molecular structure or the like can be obtained.

### Second Embodiment

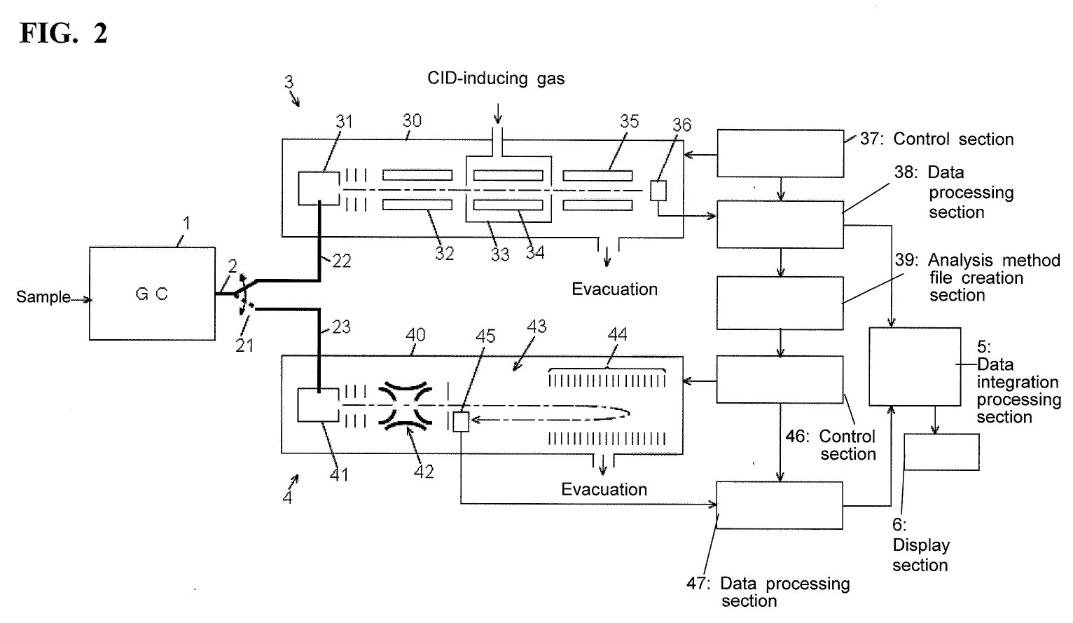

In the first embodiment, a sample is introduced into the two mass spectrometry apparatuses 3, 4 in a parallel manner. This configuration has an advantage of saving an analysis time, whereas it is necessary to adjust a delay time to adequately set a sample introduction timing as described above. A mass spectrometry system according to a second embodiment of the present invention is designed such that respective mass spectrometric analyses in the two mass spectrometry apparatuses 3, 4 are not performed concurrently but at different times. FIG. 2 is a block diagram schematically showing a mass spectrometry system according to the second embodiment. In FIG. 2, the same component or element as that in the first embodiment is defined by a common reference numeral, and its description will be omitted.

In the mass spectrometry system according to the second embodiment, components of a sample separated by a GC section 1 are selectively introduced into either one of a triple quadrupole-type mass spectrometry apparatus 3 and an ion trap time-of-flight mass spectrometry apparatus 4 by switching between a first sample introduction section 22 and a second introduction section 23. Although each of the triple quadrupole-type mass spectrometry apparatus 3 and the ion trap time-of-flight mass spectrometry apparatus 4 has the same structure as that of each of the mass spectrometry apparatuses 3, 4 in the first embodiment, information and a signal of a data processing section 38 associated with the triple quadrupole-type mass spectrometry apparatus 3 are input into an analysis method file creation section 39.

The analysis method file creation section 39 has a function of creating an analysis method file formed by organizing an analysis condition and a procedure for allowing the ion trap time-of-flight mass spectrometry apparatus 4 to perform a mass spectrometric analysis for a specific ion which is identified by a mass spectrometric analysis in the triple quadrupole-type mass spectrometry apparatus 3. For example, the analysis method file includes information about a retention time of a target sample component on the basis of a time when a sample is injected into the GC section 1 (i.e., an elapsed time from the sample injection timing through until the target sample component into the triple quadrupole-type mass spectrometry apparatus 3). The analysis method file is given to a control section 46, and the control section 46 receives therefrom an instruction for initiation of a mass spectrometric analysis in the ion trap time-of-flight mass spectrometry apparatus 4. Then, the control section 46 controls each device of the ion trap time-of-flight mass spectrometry apparatus 4 in accordance with the analysis method file.

Thus, in the GC/MS system according to the second embodiment, the ion trap time-of-flight mass spectrometry apparatus 4 associated with the GC section 1 can perform a mass spectrometric analysis for the same sample as that in the triple quadrupole-type mass spectrometry apparatus 3, based on the analysis method file, so as to obtain detailed (i.e., high-accuracy) mass information and an MSⁿ spectrum about the target sample component.

The above embodiments have been shown and described by way of example. It is to be understood that various changes and modifications will be apparent to those skilled in the art. Therefore, unless otherwise such changes and modifications depart from the scope of the present invention hereinafter defined, they should be construed as being included therein. For example, although the mass spectrometry system according to each of the above embodiments is designed in combination with a gas chromatograph, the present invention may be designed in combination with a liquid chromatograph, or may be used as an independent mass spectrometry system without being combined with a chromatograph.

1. A mass spectrometry system comprising:
a) a first mass spectrometry apparatus which is a triple quadrupole-type mass spectrometry apparatus;
b) a second mass spectrometry apparatus using a mass separation method different from that in said first mass spectrometry apparatus and having a capability to achieve a mass accuracy greater than that of said first mass spectrometry apparatus;
c) sample introduction means adapted to introduce a same sample into each of said first mass spectrometry apparatus and said second mass spectrometry apparatus, simultaneously or with a given time delay therebetween, in a parallel manner;
d) information extraction means operable, based on a detection signal obtained by a mass spectrometric analysis in said first mass spectrometry apparatus with respect to said sample introduced by said sample introduction means, to extract information about a predetermined specific ion; and
e) control means operable to control an operation of said second mass spectrometry apparatus to allow said second mass spectrometry apparatus to perform a mass spectrometric analysis for said specific ion originating from said sample introduced by said sample introduction means, in accordance with said information extracted by said information extraction means.

2. A mass spectrometry system comprising:
a) a first mass spectrometry apparatus which is a triple quadrupole-type mass spectrometry apparatus;
b) a second mass spectrometry apparatus using a mass separation method different from that in said first mass spectrometry apparatus and having a capability to achieve a mass accuracy greater than that of said first mass spectrometry apparatus;
c) sample introduction means adapted to selectively introduce a same sample into either one of said first mass spectrometry apparatus and said second mass spectrometry apparatus;
d) information extraction means operable, based on a detection signal obtained by a mass spectrometric analysis in said first mass spectrometry apparatus with respect to said sample introduced by said sample introduction means, to extract information about a predetermined specific ion; and
e) file creation means operable, based on the information about said specific ion extracted by said information extraction means, to create a file including an analytical condition and procedure for allowing said second mass spectrometry apparatus to perform a mass spectrometric analysis for said specific ion; and
f) control means operable to control an operation of said second mass spectrometry apparatus to allow said second mass spectrometry apparatus to perform said mass spectrometric analysis for said specific ion originating from said sample introduced by said sample introduction means, in accordance with said file created by said file creation means.

3. A mass spectrometry system comprising:
a) a first mass spectrometry apparatus which is a triple quadrupole-type mass spectrometry apparatus;
b) a second mass spectrometry apparatus operable to repeat an operation of selecting a specific ion and inducing fragmentation of said selected ion, twice or more, to form product ions, so as to perform an MSⁿ analysis for said product ions to obtain an MSⁿ analysis result (wherein n is an integer of 3 or more);
c) sample introduction means adapted to introduce a same sample into each of said first mass spectrometry apparatus and said second mass spectrometry apparatus, simultaneously or with a given time delay therebetween, in a parallel manner;
d) information extraction means operable, based on a detection signal obtained by a mass spectrometric analysis in said first mass spectrometry apparatus with respect to said sample introduced by said sample introduction means, to extract information about a predetermined specific ion; and
e) control means operable to control an operation of said second mass spectrometry apparatus to allow said second mass spectrometry apparatus to perform said MSⁿ analysis for said specific ion originating from said sample introduced by said sample introduction means and serving as a target ion, in accordance with said information extracted by said information extraction means.

4. A mass spectrometry system comprising:
a) a first mass spectrometry apparatus which is a triple quadrupole-type mass spectrometry apparatus;
b) a second mass spectrometry apparatus operable to repeat an operation of selecting a specific ion and inducing fragmentation of said selected ion, twice or more, to form product ions, so as to perform an MSⁿ analysis for said product ions to obtain an MSⁿ analysis result (wherein n is an integer of 3 or more);
c) sample introduction means adapted to selectively introduce a same sample into either one of said first mass spectrometry apparatus and said second mass spectrometry apparatus;
d) information extraction means operable, based on a detection signal obtained by a mass spectrometric analysis in said first mass spectrometry apparatus with respect to said sample introduced by said sample introduction means, to extract information about a predetermined specific ion; and
e) file creation means operable, based on the information about said specific ion extracted by said information extraction means, to create a file including an analytical condition and procedure for allowing said second mass spectrometry apparatus to perform said MSⁿ analysis for said specific ion; and
f) control means operable to control an operation of said second mass spectrometry apparatus to allow said second mass spectrometry apparatus to perform said MSⁿ analysis for said specific ion originating from said sample introduced by said sample introduction means and serving as a target ion, in accordance with said file created by said file creation means.

5. The mass spectrometry system as defined in claim 1, wherein said first mass spectrometry apparatus is operable to perform a precursor ion scan or a neutral loss scan to detect a specific ion based on a result of said scan.

6. The mass spectrometry system as defined in claim 1, which is configured to integrate respective analysis results obtained by said first and second mass spectrometry apparatuses with respect to said same sample, and display or process said integrated analysis result.

7. The mass spectrometry system as defined in claim 5, which is configured to integrate respective analysis results obtained by said first and second mass spectrometry apparatuses with respect to said same sample, and display or process said integrated analysis result.

8. The mass spectrometry system as defined in claim 2, wherein said first mass spectrometry apparatus is operable to perform a precursor ion scan or a neutral loss scan to detect a specific ion based on a result of said scan.

9. The mass spectrometry system as defined in claim 8, which is configured to integrate respective analysis results obtained by said first and second mass spectrometry apparatuses with respect to said same sample, and display or process said integrated analysis result.

10. The mass spectrometry system as defined in claim 2, which is configured to integrate respective analysis results obtained by said first and second mass spectrometry apparatuses with respect to said same sample, and display or process said integrated analysis result.

11. The mass spectrometry system as defined in claim 3, wherein said first mass spectrometry apparatus is operable to perform a precursor ion scan or a neutral loss scan to detect a specific ion based on a result of said scan.

12. The mass spectrometry system as defined in claim 11, which is configured to integrate respective analysis results obtained by said first and second mass spectrometry apparatuses with respect to said same sample, and display or process said integrated analysis result.

13. The mass spectrometry system as defined in claim 3, which is configured to integrate respective analysis results obtained by said first and second mass spectrometry apparatuses with respect to said same sample, and display or process said integrated analysis result.

14. The mass spectrometry system as defined in claim 4, wherein said first mass spectrometry apparatus is operable to perform a precursor ion scan or a neutral loss scan to detect a specific ion based on a result of said scan.

15. The mass spectrometry system as defined in claim 14, which is configured to integrate respective analysis results obtained by said first and second mass spectrometry apparatuses with respect to said same sample, and display or process said integrated analysis result.

16. The mass spectrometry system as defined in claim 4, which is configured to integrate respective analysis results obtained by said first and second mass spectrometry apparatuses with respect to said same sample, and display or process said integrated analysis result.
